(19) United States
(12) Patent Application Publication
(10) Pub. No.: US 2006/0072055 A1
(43) Pub. Date: Apr. 6, 2006

(54) Color filter and liquid crystal display device using it, and their manufacturing methods

(75) Inventor: Yusei Ukawa, Kobe-shi (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/538,280

(22) PCT Filed: Dec. 11, 2003
(86) PCT No.: PCT/IB03/05948

§ 371 Date: Jun. 10, 2005

(30) Foreign Application Priority Data
Dec. 17, 2002 (JP) 2002-365325

(51) Int. Cl. G02F 1/1335

(52) U.S. Cl. 349/114; 349/106

(57) ABSTRACT

An object of the invention is to acquire uniform color purity within a pixel to make a good color reproduction and to easily manufacture it with few constraints. A color filter for coloring a first light ray L1 having a unidirectional optical path and a second light ray L2 having a bidirectional optical path for each pixel (10). The color filter comprises: a first coloring portion 10t for coloring the first light ray L1 and a second coloring portion L2 for coloring the second light ray L2, the first coloring portion 10t having a greater thickness than the second coloring portion 10r, the first coloring portion 10t being formed in subsidence with respect to the second coloring portion 10r with a principal plane of the first coloring portion 10t being different in height from a principal plane of the second coloring portion 10r by a predetermined value D.

### BACKGROUND OF THE INVENTION

1. Field of the Invention

The present invention relates to a color filter. The invention also relates to a liquid crystal display device using the color filter.

The present invention especially relates to a color filter handling a first light ray and a second light ray. The first light ray forms a unidirectional optical path in which incident light from one principal plane side of the color filter is transmitted through the filter only once to be colored and is led to the other principal plane side. The second light ray forms a bidirectional optical path in which incident light from the other principal plane side of the color filter is transmitted through the filter to be colored, and the transmitted light is reflected by a light reflective element or the like disposed on the one principal plane side to enter the filter again, transmitted through the filter to be colored and returned to the other principal plane side. The invention also relates to a method of manufacturing the color filter. The invention further relates to a liquid crystal display device using such a color filter and a method of manufacturing the liquid crystal display device.

2. Description of the Related Art

A so-called transflective liquid crystal display device is entering into a full-fledged stage of practical utilization, wherein external light incident from the front side is reflected to be guided to the front side while being provided with an optical modulation according to the image to be displayed, and incident light from the back light system on the rear side is passed to the same front side while being likewise provided with the optical modulation according to the image to be displayed. This type of liquid crystal display device effectively performs displays of image based on the external light (ambient light) mainly when the operating environment is bright (reflective mode) and based on emission light from the back light system mainly when it is dark (transmissive mode) (for example, see Non-Patent Document 1).

[Non-Patent Document 1]

M. Kubo, et al. “Development of Advanced TFT with Good Legibility under Any Intensity of Ambient Light”, IDW' 99, Proceedings of The Sixth International Display Workshops, AMD34, sponsored by ITE and SID, (Japan), Dec. 1, 1999, page 183-186

In the apparatus disclosed in the above described document, each pixel electrode is divided into a reflective area and a transmissive area. The reflective area is formed into a reflective electrode part made of aluminum over acrylic resin having an uneven surface and the transmissive area is formed into a transparent electrode part made of ITO (indium tin oxide) having a flat surface. Furthermore, the transmissive area is situated in the center of one rectangular pixel area and has a substantially similar rectangular figure like the pixel area, whereas the reflective area forms a part of the pixel area other than the rectangular transmissive area and has a form of surrounding the transmissive area By virtue of the pixel configuration, the visibility is improved.

However, in the case of the liquid crystal display device according to this prior art, the transmissive and the reflective area are different in color purity of the displayed color though they are in the same pixel. This may be attributable to the fact that a light ray from the backlight system and the external light ray, which travel through different optical paths, are colored in the same fashion by the color filter of the prior art. This results in deterioration in quality of displayed colors over the display area.

Furthermore, according to the prior art, the reflective electrode part is formed higher than the transmissive electrode part by the presence of acrylic resin below the reflective electrode part. Then, based on this structure, a liquid crystal cell gap in the transmissive area is made to a thickness twice that of the reflective area to adjust optical characteristics of the respective areas.

However, the structure forming such a dual cell gap within a pixel is subject to many constraints of other elements such as a TFT forming layer, which is disadvantageous in terms of manufacturing. Furthermore, since the conductor of the reflective electrode part extends to and couples with the end of the transmissive electrode part which is smaller in height than the reflective electrode part, undesirable reflected light may occur in the coupling area (or boundary portion) and the inclined surface thereof. That is, since a cell gap corresponding to the coupling area is originally intended for transmitted light, the reflected light generated here does not match retardation caused by the liquid crystal portion in the transmissive mode and may constitute optical noise. This also constitutes a factor for deterioration of contrast.

### SUMMARY OF THE LION

The present invention has been implemented in view of the above-described circumstances and its object is to provide a color filter and a liquid crystal display device using the filter, which acquires uniform color purity within a pixel to make a good color reproduction and can be easily manufactured with few constraints.

It is another object of the present invention to provide a color filter and a liquid crystal display device using it, which can acquire uniform color purity within a pixel to make a good color reproduction and can avoid an occurrence of undesired reflected light as described above.

It is a further object of the present invention to provide methods of manufacturing such color filter and liquid crystal display device.

In order to attain the above-mentioned objects, a color filter according to an aspect of the present invention is a color filter for coloring a first light ray having a unidirectional optical path and a second light ray having a bidirectional optical path for each pixel, comprising: a first coloring portion for coloring the first light ray and a second coloring portion for coloring the second light ray, the first coloring portion having a greater thickness than the second coloring portion, the first coloring portion being formed in subsidence with respect to the second coloring portion with a principal plane of the first coloring portion being different in height from a principal plane of the second coloring portion by a predetermined value.

According to this aspect, the first coloring portion is thicker than the second coloring portion, and therefore the first right ray, which has a unidirectional optical path and on which the coloring effect can be exerted only once, is subjected to a relatively large coloring effect, whereas the second light ray, which has a bidirectional optical path and on which the coloring effect can be exerted twice, is subjected to a relatively small coloring effect. In this way, even if the first and second coloring portions are formed of the same material, it is possible to reproduce the color with more uniform color purity within a pixel for the first and second light rays, and thereby to improve the quality of color displays over the screen.

In addition, by forming the principal plane of the first coloring portion lower in height than the principal plane of the second coloring portion, that is, forming the first coloring portion in subsidence in appearance, it is achieved to easily form a difference between the liquid crystal cell gaps for the first light ray and second light ray. More specifically, the invention is emancipated from restrictions of other complicated constructions such as a TFT-forming layer for creating a structure of a cell gap difference on the rear substrate in the conventional art, and it is possible to create a cell gap difference practically simply on the front substrate that only requires relatively simple structure. This is particularly advantageous because a color filter which can be easily patterned is used. Furthermore, this scheme also has the advantage that it is possible to specify the structure, value or the like for the cell gap difference with a high degree of freedom.

In this aspect, the predetermined value may be a value required to substantially equalize or mutually optimize a first optical effect and a second optical effect, the first optical effect being to be exerted on the first light ray by a portion of a liquid crystal layer corresponding to the first coloring portion, and the second optical effect being to be exerted on the second light ray by a portion of the liquid crystal layer corresponding to the second coloring portion when the liquid crystal layer is used in a liquid crystal display panel to which the color filter is applied. By so doing, the color filter can be a main member for forming a liquid crystal cell gap that substantially equalizes or mutually optimizes the optical effects to be exerted on the first light ray and the second light ray handled by the liquid crystal display device to which the color filter is applied. Furthermore, by making the optical effect to be an effect of causing retardation, it is possible to give substantially equal or mutually optimized retardation to the first light ray and the second light ray and apply equal or mutually suitable optical modulation to the first light ray and the second light ray while keeping the same optical axes of the polarizing plate and other optical elements used therein.

The first and second coloring portions may have their respective thicknesses such that the first coloring portion provides a greater coloring effect than the second coloring portion when a light ray of the same optical path and the same property is transmitted through the first and second coloring portions, further the first coloring portion may have a thickness substantially twice as great as the second coloring portion. In this way, the thicknesses of the first and second coloring portions are specified appropriately or to a high degree, assuring the above-mentioned achievement of uniform color purity within a pixel. Beside, making the first coloring portion have a thickness substantially twice as great as the second coloring portion acquires satisfactory color reproducibility within a pixel or over the display face.

Preferably, the color filter further may comprise a step-forming layer of an optical transmissive material, which supports the second coloring portion for providing the first and second coloring portions with thicknesses different from each other by the predetermined value. By so doing, it is possible to beforehand form a step structure on the surface on which the coloring layer is to be deposited and readily form a difference in height between the first and second coloring portions. Furthermore, if the step-forming layer is colorless and transparent, there is no influence on the coloring effect of the second coloring portion.

Also in this aspect of the present invention, the step-forming layer may include an optically transmissive base material and multiple particles of optically transmissive material having a refractive index different from a refractive index of the base material and being scatteringly mixed into the base material. Accordingly, it is possible to provide the step-forming layer with an optical diffusion (scattering) characteristic and thereby to selectively diffuse only the second light ray. This lessens the necessity to provide other members with the diffusing function for the second light ray, and it is allowed to provide a diffusing effect suitable for the second light ray in the reflective mode independently of the diffusion for the first light ray. That is, since the first light ray can do without receiving any diffusion effect, it has the merit of not causing any deterioration in contrast or reduction in transmittance. In addition, providing the step-forming layer with a sufficient diffusing property eliminates the need for forming an optically diffusive layer on the substrate on which TFTs, etc., are formed and makes it possible to omit a process of forming such an optically diffusive layer. Especially, since the step-forming layer is characterized by a considerably large thickness thereof for creating the liquid crystal cell gap difference, it is possible to mix a greater number of optically transmissive particles into the step-forming layer, which is more convenient to provide it with an enough a fill diffusion property as such, and this embodiment thus exerts synergetic effect with this characterized feature.

Furthermore, in order to attain the above-mentioned objects, a liquid crystal display device according to another aspect of the present invention uses the color filter of the above-described aspect.

In this aspect, the color filter may be provided on a substrate at a display face side of the liquid crystal display device; the opposite substrate may be provided with a pixel electrode comprising a transmissive electrode part for causing the first light ray to be transmitted therethrough and a reflective electrode part for causing the second light ray to be reflected therefrom; and an area of the first coloring portion may be aligned with an area of the transmissive electrode part, and an area of the second coloring portion is aligned with an area of the reflective electrode part. Such a liquid crystal display device makes color purity within each pixel to be uniform and makes it possible to obtain high quality of color displays in any of a reflective mode, a transmissive mode and a mode in which these modes are intermingled.

Here, the transmissive electrode part and the reflective electrode part may have principal surfaces of substantially the same height. In this way, it is possible not only to acquire uniform color purity within a pixel and make a good color reproduction but also to avoid an occurrence of the above-described unnecessary reflected light. In other words, since the inclined portion formed to combine the electrical conductor of the reflective electrode part with the transmissive electrode part becomes smaller, it is possible to suppress the unexpected reflected light that could occur in the inclined portion. Therefore, the light that does not match retardation of the liquid crystal layer is reduced, and it is possible to contribute to improvement of contrast.

Alternatively, there may be a difference of height between principal surfaces of the transmissive electrode part and reflective electrode part and a sum value of this difference of height and the predetermined value may be a value required to substantially equalize a first optical effect and a second optical effect, the first optical effect being to be exerted on the first light ray by a portion of a liquid crystal layer corresponding to the transmissive electrode part, and the second optical effect being to be exerted on the second light ray by a portion of the liquid crystal layer corresponding to the reflective electrode part when the liquid crystal layer is used in a liquid crystal display device to which the color filter is applied. By so doing, it is possible to efficiently form an appropriate liquid crystal cell gap difference without the need to make the above-described adjustment of the heights of the transmissive electrode part and the reflective electrode part with a considerably high degree of accuracy, by virtue of using the recess produced in the transmissive electrode part from a backward point of view.

Furthermore, in order to attain the above-mentioned objects, a method of manufacturing a color filter according to a further aspect of the present invention is a method of manufacturing a color filter for coloring a first light ray having a unidirectional optical path and a second light ray having a bidirectional optical path for each pixel, comprising the steps of: depositing an optically transmissive material on a base layer, patterning the deposited layer of optically transmissive material to form a step forming layer wherein at least one recess-shaped portion is formed for a pixel, the recess-shaped portion having a bottom face of a predetermined shape corresponding to an area wherein the first light ray is caused to be transmitted and a wall face of a predetermined height; and depositing a material for coloring the first and second light rays on the step forming layer and the recess-shaped portion so as to form a first coloring portion for coloring the first light ray and a second coloring portion for coloring the second light ray, the first coloring portion having a greater thickness than the second coloring portion, the first coloring portion being formed in subsidence with a principal surface of the first coloring portion being different in height from a principal surface of the second coloring portion by a predetermined value.

This makes it possible to manufacture a color filter which exerts the above-described effects in a relatively simple way.

Furthermore, in order to attain the above-mentioned objects, a method of manufacturing a liquid crystal display device according to a still further aspect of the present invention is a method of manufacturing a liquid crystal display device, comprising the steps included in the above-mentioned color filter manufacturing method, wherein the color filter is provided to one substrate of the liquid crystal display device and the other, opposed substrate is provided with a pixel electrode comprising a transmissive electrode part for making the first light ray to be transmitted therethrough and a reflective electrode part for making the second light ray to be reflected therefrom, the display device manufacturing method further comprising the step of aligning the first coloring portion with the transmissive electrode part and aligning the second coloring portion with the reflective electrode part.

In this way, it is possible to manufacture a liquid crystal display device which can fully make the most of the advantages of the above-described color filter.

This aspect may further comprise a pixel electrode forming step of forming the transmissive and reflective electrode parts in substantially the same heights. This liberates the system from a complicated structure in which the transparent electrode part and reflective electrode part must be formed in different heights and makes it possible to make the opposed side substrate to be flattened, that is, the finished surface of the substrate assembly on which the a so-called pixel driving elements are formed to be flattened, resulting in easy handling or other processing for it

### BRIEF DESCRIPTION OF THE DRAWINGS

FIG. 1 is a schematic plan view of a color filter used in a liquid crystal display device according to a first embodiment of the present invention.

FIG. 2 is a schematic section view of a liquid crystal display panel incorporated with the color filter of FIG. 1.

FIG. 3 is a schematic section view of a substrate assembly incorporated with a color filter according to a second embodiment of the invention.

FIG. 4 is an illustration showing an example of form in which a height of a transmissive electrode part is made equalized with a height of a reflecting electrode part in a liquid crystal display device according to the invention.

FIG. 5 is an illustration showing a further example of form in which a height of a transmissive electrode part is made equalized with a height of a reflecting electrode part in a liquid crystal display device according to the invention.

FIG. 6 is an illustration showing yet another example of form in which a height of a transmissive electrode part is made equalized with a height of a reflecting electrode part in a liquid crystal display device according to the invention.

FIG. 7 is a schematic section view of a substrate assembly incorporated with a color filter of a modification according to the invention.

### DESCRIPTION OF THE PREFERED EMBODIMENT(S)

Now the above-mentioned aspects and other modes for currying out the invention will be described in more detail by way of embodiment with reference to the accompanying drawings.

### Embodiment 1

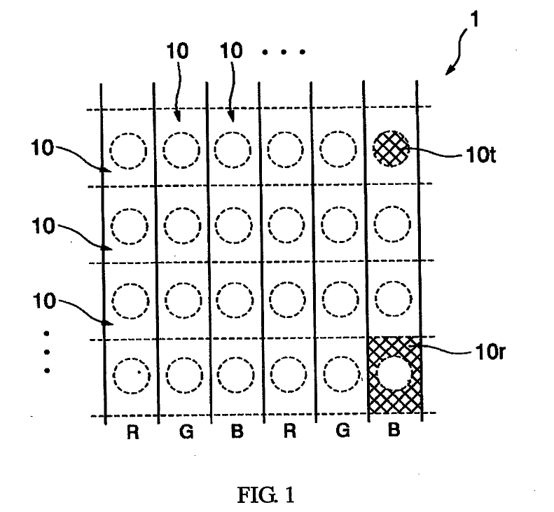

FIG. 1 shows in schematic plan view a color filter 1 used in a liquid crystal display device according to a first embodiment of the present invention.

This color filter 1 is partitioned longitudinal coloring areas each extending in the vertical direction of a display screen and having one of red (R), green (G) and blue (B) coloring matters. These longitudinal coloring areas are cyclically arranged in the horizontal direction of the display screen in order of R, G and B. One longitudinal coloring area can be further divided in the vertical direction, and each of the divisional portions corresponds to one pixel. Hereinafter, this divisional portion will be referred to as a “pixel area portion 10.” It is noted that althiugh the longitudinal coloring areas are divided in the vertical direction by dotted lines in FIG. 1, the pixel area portions 10 in one longitudinal coloring area (pixel area portions 10 arranged in the vertical direction) are neither isolated materially nor physically in this embodiment The dotted lines just show boundaries between pixels.

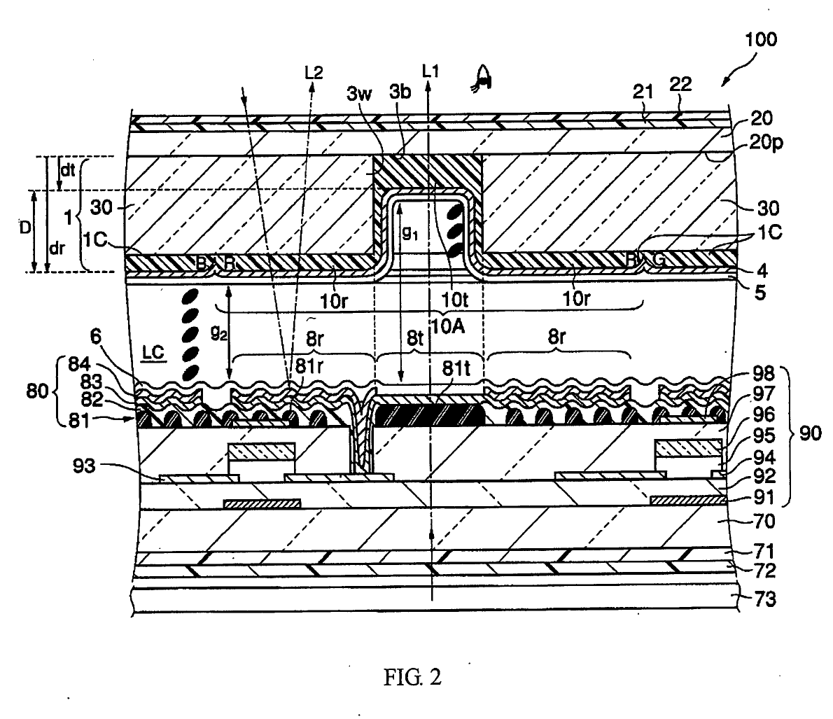

FIG. 2 shows a cross section of a liquid crystal display panel 100 incorporating this color filter. FIG. 2 shows a basic configuration of the liquid crystal display panel, in which layers, films and structures not shown here are omitted for the sake of clarity of the description.

The pixel area portion 10 of the color filter is divided into a first coloring portion 10t for a transmitted light ray L1 as a first light ray (area depicted in cross hatching of the pixel area portion shown at the upper right in FIG. 1; the same applies to other pixels) and a second coloring portion 10r for a reflected light ray L2 as a second light ray (area depicted in cross hatching of the pixel area portion shown at the lower right in FIG. 1; the same applies to other pixels). The first coloring portion 10t and the second coloring portion 10r are arranged in correspondence with and aligned with a transmissive electrode part 8t and a reflective electrode part 8r of a pixel electrode 80 provided on a transparent substrate 70 which faces these coloring portions via a medium of a liquid crystal layer LC.

The first coloring portion 10t here is shaped like substantially a circle whose center is located in the center of the pixel area, and the second coloring portion 10r is the rest of the pixel area in form of surrounding the first coloring portion 10t (see FIG. 1). Therefore, in this embodiment, it is assumed that the electrode parts in the pixel electrode 80 also have the shapes equivalent to those of the coloring portions lot and 10r in the plan view, respectively.

As shown in FIG. 2, the color filter 1 comprises: a transparent resin layer 30 as a step-forming layer provided on a transparent substrate 20 on the front side of a liquid crystal display panel 100 and formed inside the panel; and a coloring layer 1C made of the same kind of material and laminated over the entire surfaces of the transparent substrate 20 and the transparent resin layer 30. This coloring layer 1C forms the above-described first coloring portion 10t and the second coloring portion 10r for each pixel.

The transparent resin layer 30 is patterned in the same form as the area other than the entire first coloring portion 10t (that is, the area of the entire second coloring portion 10r) in the plan view. More specifically, the transparent resin layer 30 can be supported by the substrate 20, and is patterned to form a recess-shaped portion including a bottom face 3b having a predetermined shape corresponding to the area allowing the transmitted light L1 to pass therethrough and a wall face 3w with a predetermined height in one pixel (area), so as to form a step on its surface on which the coloring layer 1C is to be deposited

In this embodiment, only a part of the transparent resin material corresponding to the first coloring portion 10t is removed so that an opening (or window) through which the transparent substrate 20 is exposed is formed in the area of the removed part. The coloring layer 1C forms the first coloring portion 10t in such an opening area and forms the second coloring portion 10r in the other area, that is, the patterned area of the transparent resin layer 30.

As is apparent from the figure, the first coloring portion 10t is formed thicker than the second coloring portion 10r. Furthermore, the first coloring portion 10t is formed caved in, that is, in subsidence with respect to the second coloring portion 10r and there is a difference of a predetermined value D between the principal plane of the first coloring portion 10t and the principal plane of the second coloring portion 10r.

It is noted that, in this example, the first coloring portion 10t is directly supported by the transparent substrate 20 and the second coloring portion 10r is supported via the transparent resin layer 30, and the heights here refer to heights dt and dr of the coloring portions 10t and 10r from the support surface (principal plane) 20p of the transparent substrate 20.

The liquid crystal display panel 100 in this embodiment adopts an active matrix system using thin-film transistors (TFTs) as pixel driving elements, but the present invention is not necessarily limited to it.

The liquid crystal display panel 100 includes a front transparent substrate 20 disposed on an entrance side of the external light and a rear transparent substrate 70 disposed facing the substrate 20 at a predetermined distance. A liquid crystal layer LC in which spacers are mixed is sealed in the gap between the front side substrate 20 and rear side substrate 70 using a sealing member (not shown). The liquid crystal layer LC serves as an electro-optical medium which performs optical modulation according to an image to be displayed.

On the inside of the front side substrate 20, there are provided the above-mentioned color filter 1, a common electrode 4 consisting of a transparent electrically-conductive material such as ITO (indium tin oxide) and an orientation film 5 which defines the initial orientation of the topside of the liquid crystal layer LC in this order.

The rear side substrate 70 is provided on the inside with a TFT-composite layer 90 in which pixel driving TFTs, etc., are formed, the above-mentioned pixel electrode layer 80 and an orientation film 6 for defining the initial orientation of the underside of the liquid crystal layer LC in this order.

In the TFT-composite layer 90, a light shield film 91 formed on the substrate 70 for each transistor and an electrical insulating layer 92, e.g. of SiO₂ laminated on the light shield film 91 are provided, and on top of this insulating layer, a source electrode 93 and a drain electrode 94 are formed away form each other in association with the light shield film 91, and a semiconductor layer 95 is formed between the source electrode 93 and drain electrode 94 to connect them at their respective ends. A gate insulating film 96 is laminated on the semiconductor layer 95, and a gate electrode 98 is further formed via a second gate insulating film 97 having an opening for connection with the drain electrode. The TFT in such a configuration is formed for each of all pixels.

On such a TFT-composite layer 90, there is formed a certain structure for providing the reflective electrode part 8r of the above-described pixel electrode 80 with an optical diffusion characteristic and for equalizing the average height of the reflective electrode part 8r with that of the transmissive electrode part 8t.

This structure is provided with a resist film 81 which has many relatively fine uneven cross-sections 81r in the area of the gate insulating film 97 and gate electrode 98 corresponding to the above-mentioned reflective electrode part 8r and a lump of flat extending cross-section 8 It in the area corresponding to the above-mentioned transmissive electrode part 8t. On this resist film 81, a bumps and dips adjustment resist film 82 is provided which has a drain electrode connection opening (contact hole).

It is noted that this embodiment adopts a structure such that the top face of the cross-sectional portion 81t of the resist film 81 is not coated with the resist film 82. This is because it taken into account that the degree of contraction of the flat cross-section portion 81t of the resist film 81 is lower than that of the uneven cross-sectional portion 81r in the resist setting processing. That is, since the flat cross-section 8 it has a lower degree of contraction and for this very reason it may be formed higher than the uneven cross-sections 81r, the second resist film 82 is not laminated intentionally but the section 81 is made to have the same height as the average height of the second resist film 82 which has been stacked on the uneven cross-sections 81r.

On the resist film 82 and the opening thereof a transparent conductor layer 83 of ITO or the like is formed for each pixel area so as to extend over the entire pixel area while keeping a connection to the drain electrode 94 through the opening provided in the film 82 and gate insulating film 97. On the transparent conductor layer 83, a reflective conductor layer 84 is formed, which is of a material such as aluminum that has not only electrical conductivity but also optical reflectiveness. This reflective conductor layer 84 forms the above-mentioned reflective electrode part 8r and is patterned so that an opening (circle in this example) corresponding to the area of the above-mentioned transmissive electrode part 8t is formed therein. The part of the transparent conductor layer 83 exposed through such an opening forms the above-mentioned transparent electrode part 8t. The orientation film 6 is formed over the whole area of the pixel electrode 80.

Outside the front side substrate 20, a quarter-wave plate 21 and a polarizing plate 22 are provided in this order. Outside the rear side substrate 70, a quarter-wave plate 71 and a polarizing plate 72 are also provided in this order. A backlight 73 is provided further outside the polarizing plate 72.

The first coloring portion 10t of the color filter 1 preferably has a thickness substantially twice as large as the second coloring portion 10r mainly for the following reasons.

After passing through the transparent electrode part 8t and so on, the light L1 from the backlight 73 passes through the liquid crystal layer LC, orientation film 5 and common electrode 4, then passes through the first coloring portion 10t while being colored, and is guided to the exterior of the front side of the panel. On the other hand, after passing through the transparent substrate 20 and transparent resin layer 30, the external light L2 from the front side of the panel passes through the second coloring portion 10r where it is colored once, and in addition the transmitted light reaches the reflective electrode part 8r through the liquid crystal layer LC where it is reflected by the reflective electrode part 8r, returned to the second coloring portion 10r through the liquid crystal layer LC again to be colored again, and is passed through the transparent resin layer 30 and transparent substrate 20, etc. toward the exterior of the front side of the panel.

As described above, the first coloring portion 10t is thicker than the second coloring portion 10r, and therefore even when the transmitted light L1 passes through the relevant portion only once, the first coloring portion 10t can give a relatively large coloring effect to the light. On the contrary, as the second coloring portion 10r is thinner than the first coloring portion 10t, it can not obtain such coloring effect comparable to that of the first coloring portion 10t. However, since the reflected light L2 passes through the second coloring portion 10r twice, the double coloring effect is given to the light L2. Therefore, the second coloring portion 10r only needs to have a thickness enough to give a sufficient coloring effect when the reflected light L2 passes therethrough twice, and from the standpoint of balancing with the coloring effect of the first coloring portion 10t, the second coloring portion 10t should be thinner than the first coloring portion 10t. In order to give substantially the same coloring effect when transmitted light and reflected light of the same characteristic are colored by the first coloring portion and the second coloring portion, the thickness of the first coloring portion may be set roughly twice that of the second coloring portion. However, it is also possible to specify such a coloring effect or thickness of each coloring portion considering the fact that the transmitted light is the light from the backlight 73 and the reflected light is external light or light from a front light (not shown), etc.

Thus, the transmitted light L1 and reflected light L2 which appear outside the panel front can be colored uniformly or appropriately and the color display characteristic within a pixel and over the entire screen becomes satisfactory.

Furthermore, the height dt of the principal plane of the first coloring portion 10t and the height dr of the principal plane of the second coloring portion 10r can be specified as follows.

This embodiment is arranged to determine the thicknesses of the liquid crystal layer LC in the area handling the transmitted light and the area handling the reflected light mainly by these heights dt and dr. As is apparent from the above description, while the transmitted light passes through the liquid crystal layer LC only once, the reflected light passes through the liquid crystal layer LC twice. Therefore, the former receives the optical effect exerted by the liquid crystal layer LC only once, whereas the latter receives twice. Thus, the optical path lengths in the liquid crystal layer LC are made equal so that the transmitted light and reflected light can receive the same optical effect from the liquid crystal layer LC.

More specifically, such an optical effect is an effect of causing retardation and in the case of a liquid crystal portion of the same thickness, the retardation which influences the reflected light becomes twice as great as the retardation which influences the transmitted light. In order to cancel out the difference in retardation, the first coloring portion 10t and second coloring portion 10r of the color filter are made to have a difference in height necessary to make the thickness (cell gap) of the liquid crystal portion handling the transmitted light L1 twice the thickness of the liquid crystal portion handling the reflected light L2.

For example, when the thickness g₂ of the liquid crystal portion of the liquid crystal layer LC handling the reflected light L2 is assumed to be λ/4 (λ is a wavelength of light), the thickness g₁ of the liquid crystal portion handling the transmitted light L1 is λ/2. Therefore, λ/4 is adopted as the above-mentioned predetermined value D in this case. The step-forming layer 30 has a height for realizing the value D and the thickness of the second coloring portion 10r specified for the above-described balancing of coloring effects.

By currying out such a scheme, an appropriate liquid crystal cell gap difference can be easily formed for the transmitted light L1 and reflected light L2. That is, it is allowed that the transmissive electrode part 8t and reflective electrode part 8r are formed at the same height in the rear substrate 70, whereby the system is liberated from constraints of other complicated structures including TFT-forming layer and more when a structure for creating a cell gap difference on the rear substrate. Then, a cell gap difference can be easily made in for the front substrate which only requires a relatively simple structure. It is all the more easy because a color filter easy to pattern is used. It also has an advantage of being able to specify a structure for the cell gap difference or its value with a high degree of freedom.

### Embodiment 2

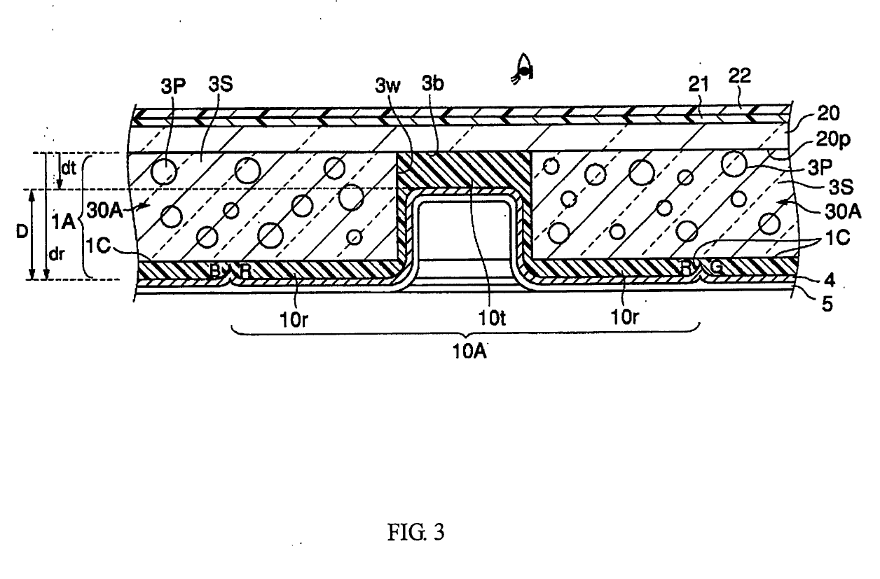

A further improved version of the above-described embodiment will be shown in FIG. 3 as a second embodiment.

A pixel area portion 10A of a color filter 1A in FIG. 3 comprises a layer 30A as a step-forming layer including an optically transmissive base material (or matrix material) 3S and many optically transmissive particles 3P which have a refractive index different from that of this base material and are scatteringly mixed thereinto. The rest of the configuration is the same as that in FIG. 2.

The step-forming layer 30A has an effect of diffusing (or scattering) light entering and passing through this layer. Such a diffusing effect is mainly caused by the difference in the refractive index between the base material 3S and particles 3P, but it also depends on parameters such as the shape and size of the particles, density of the particles in the base material or distribution state of the particles in the base material. To prevent coloring caused by interference, the particles 3P are preferably scattered in the base material at random or they are preferably non-uniform in shape or size to a certain extent. Both the base material 3S and particles 3P can be formed of synthetic resin.

Therefore, the reflected light L2 is supposed to be diffused by the step-forming layer 30A, and so there are the following advantages.

That is, while the transmitted light L1 is normally light from the backlight and generally incident on the color filter as light diffused by a light guide plate, etc., the reflected light L2 is usually external light except a case of light from a front light and such external light is incident on the color filter without being diffused. Although Embodiment 1 is intended to roughen the surface of the reflective area portion of the pixel electrode is coarsened with bumps and dips to diffuse the reflected light in consideration of the viewing angle characteristics etc., this embodiment does not rely on such roughening or allows the step-forming layer 30A to perform further diffusion to complement diffusion caused by the roughening.

Furthermore, since the step-forming layer 30A can selectively diffuse only the reflected light L2, it is possible to provide the reflected light L2 with an appropriate diffusing characteristic through the above-described parameters etc. For instance, in the configuration with a diffusing film spread over the display area on the outer surface of the display panel, there may be a situation where excessive diffusion is applied to the light L1 having already diffused by the above-described light guide plate or the like to thereby induce deterioration of transmittance and contrast in a transmissive mode. This embodiment can also cope with such a situation.

Moreover, the present invention is also adapted to a concept of equalizing the height of the transmissive electrode part with the height of the reflective electrode part. That is, flattening the reflective electrode part also facilitates equalization of heights of both electrode parts and it would be very convenient if the step-forming layer 30A can assume optical diffusion which can not be expected for the flat reflective electrode part.

Thus, in the case of a configuration providing the step-forming layer 30 with diffusiveness, there is no need to form bumps and dips on the resist film 81 or no need to require so strict degree of roughness. Therefore, it is possible to omit or simplify the bumps and dips forming step of the resist film 81.

The resin layer having the diffusion characteristic as shown in FIG. 3 itself is detailed in Japanese Patent Application Laid-Open No. 2000-330106 and can be implemented with reference to it.

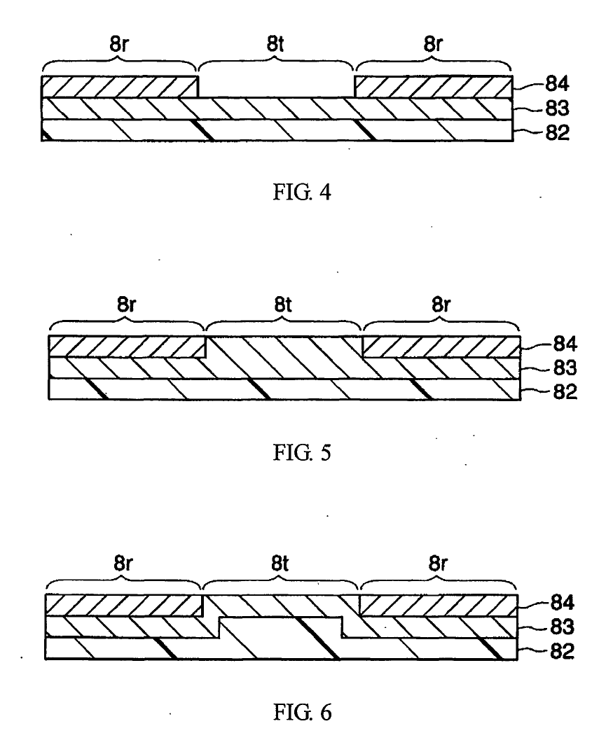

FIGS. 4 to 6 show forms for making the heights of the transmissive electrode part and reflective electrode part equal.

In FIG. 4, the above-described resist film 82 is laid flattened both in the transmissive area and reflective area, then on the film 82 the transparent conductor layer 83 is placed all around and the reflective conductor layer 84 patterned into a form with an opening for the transmissive electrode part 8t is formed. This causes the difference in height between the transmissive electrode part 8t and reflective electrode part 8r to be only a thickness corresponding to one layer of the reflective conductor layer 84.

In FIG. 5, the resist film 82 is laid flattened both in the transmissive area and reflective area, and then the transparent conductor layer 83 is placed all around but the thickness of the area corresponding to the transmissive electrode part 8t is increased. The thick portion of the transparent conductor layer 83 is made higher than other portions by a thickness of the reflective conductor layer 84. Then, on the top of this, the reflective conductor layer 84 patterned into a form with an opening for the transmissive electrode part 8t is formed. This substantially eliminates the difference in height between the transmissive electrode part 8t and the reflective electrode part 8r.

In FIG. 6, the resist film 82 is laid in such a manner that only the portion corresponding to the area of the transmissive electrode part 8t is thicker and the transparent conductor layer 83 is placed thereon all around. The thick portion of the resist film 82 here is made higher than other portion by a thickness of the reflective conductor layer 84. Then, on the top of this, the reflective conductor layer 84 patterned into a form with an opening for the transmissive electrode part 8t is formed. This substantially eliminates the difference in height between the transmissive electrode part 8t and the reflective electrode part 8r.

Thus, these configurations for making the heights of the transmissive electrode part and the reflective electrode part equal enables the area of the inclined surface in the coupling portion of them to be reduced, resulting in reduced unnecessary reflected light and effective utilization of the area of the pixel electrode for image displaying with contribution to suppression of the aperture ratio.

There may be other various techniques for making the heights of the transmissive electrode part 8t and the reflective electrode part 8r equal, but the present invention is also applicable to a case where they creates a difference in height.

That is, when there is a difference in height between the principal plane of the transmissive electrode part 8t and the principal plane of the reflective electrode part 8r and this difference can be quantitatively grasped, the optical path lengths of the transmitted light L1 and reflected light L2 in the liquid crystal layer LC may be equal to each other based on the total value of the difference and the above-mentioned predetermined value D by a similar way to the above-described concept. In the above example, the total value of a difference in height between the electrode parts and a difference in height of the color filter may be set to λ/4, and if the difference in height between the electrode parts is a certain value D′, a value of λ/4-D′ can be used as the predetermined value D to be set to the color filter.

Basically, the above-described color filters 1 and 1A can be manufactured in the following steps. That is,
(1) Step of depositing optically transmissive material on the substrate 20;
(2) Step of forming a step-forming layer 30, 30A by patterning the deposit layer of optically transmissive material with a form of at least one recess-shaped portion having a bottom face 3b of a predetermined shape and wall face 3w of a predetermined height for one pixel, the bottom face 3b corresponding to an area for making the transmitted light L1 to be transmitted therethrough; and
(3) Step of forming the first coloring portion 10t and second coloring portion 10r by depositing a coloring material for the transmitted light and reflected light on the recessed part and step-forming layers 30, 30A, while the thicknesses as and heights are set as already described.

The liquid crystal display device using such a color filter may be manufactured by including a step of aligning the transmissive and reflective areas of the color filter with those of the pixel electrodes. This case can adopt the step of forming the transmissive electrode part and reflective electrode part of the pixel electrode in substantially the same heights.

It is noted that providing a protective film covering the coloring portions lot and 10r prevents the coloring matters from directly touching other layers such as the common electrode layer 4 and orientation film 5, and therefore an advantage of preventing contamination of the other layers can also be expected.

Furthermore, in the above-described embodiment, there has been described the case where the pixel area portion 10 corresponding to a pixel of the color filter is divided into to two sub-areas of the circular first coloring portion 10t for transmission and the second coloring portion 10r for reflection which surrounds the first coloring portion, but the present invention is not necessarily limited to this example. The pixel area 10 may also be divided into three or more sub-areas, and the shape, arrangement and the number of sub-areas can also be defined an appropriate.

Basically, the transmission area and reflection area in the color filter correspond to areas assigned to the above-mentioned first light and second light handled by the display device in question (in the given embodiments here, areas of the transmissive part and reflective part formed in the pixel electrode) and have the same shape, arrangement and the number of areas. Therefore, instead of the configuration of the circular first coloring portion 10t and the second coloring portion 10r surrounding the first coloring portion as in the above-described embodiments, it is also possible to make the first coloring portion to be rectangle-shaped in the plan view or substantially rectangular but roundish shaped (including elliptic) or shaped like a polygon enclosed with 5 or more sides of line segments. It should be noted that it is advantageous in respect of forming the desired pattern accurately to form the recessed part of the step-forming layers 30, 30A in a shape having at least part of the contour of a polygon having large interior angles or a curve with a large radius of curvature in the plan view. This is more important for a display device with a screen made up of finer pixels.

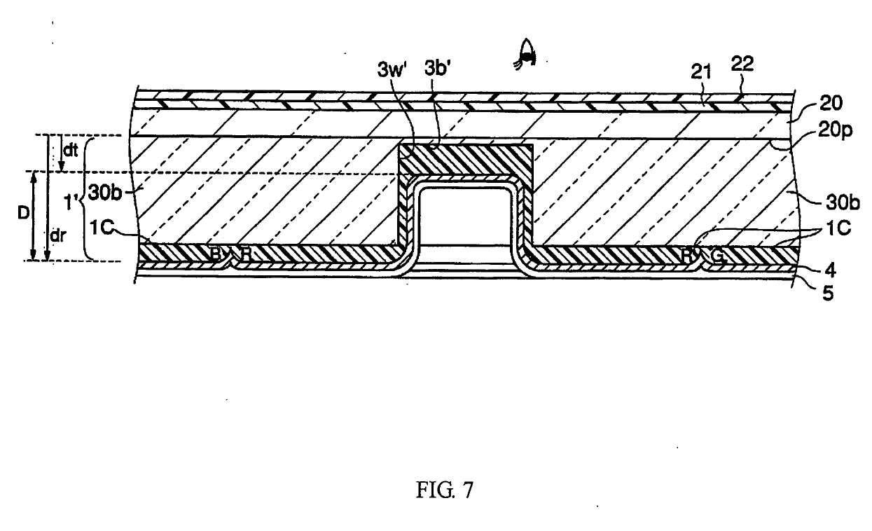

It goes without saying that there can be various modifications in the present invention. For instance, the pixel area portion naturally need not be grip-patterned as shown in FIG. 1. Furthermore, the recessed part formed in the transparent resin layer 30, 30A forms a complete opening which allows the substrate 20, that is a support layer, to be exposed and its bottom face is a surface of the substrate 20, but as shown in FIG. 7, a step-forming layer 30′ having a wall face 3w′ of the recess portion may be formed in such a manner that a bottom face 3b′ is formed with a bottom-partial transparent resin layer 30b which made of the same material and thinner.

Furthermore, the above embodiments have been described with regard to an example where a color filter is directly formed on the substrate 20, but it is also possible to insert some foundational layer between the substrate 20 and the color filter 1 or 1A. That is, the present invention is intended for any color filters supported by any base layer including such a foundational layer and substrate.

Furthermore, in addition to making the transparent resin layer completely colorless and transparent, it is also possible to use the transparent resin layer with some coloring property for a desired purpose. Moreover, the above embodiments have been described as for a color filter having three primary colors of R, G and B to create a full color image, but the present invention is also applicable to a color filter with a single color dedicated to monochrome images. In the above embodiments, additional components such as a black matrix, etc., required by some display systems as appropriate have not been described, but the present invention does not exclude such components.

The, preferred embodiments described herein are therefore illustrative and not restrictive. The scope of the present invention is indicated by the appended claims and all variations which come within the meaning of the claims are intended to be embraced therein.

[Explanation of Symbols]
1 . . . color filter
10, 10A . . . pixel area portion
10t . . . first coloring portion
10r . . . second coloring portion
1C . . . coloring layer
100 . . . liquid crystal display panel
20 . . . transparent substrate
21 . . . quarter-wave plate
22 . . . polarizing plate
30, 30A, 30b . . . transparent resin layer
3b, 3b′ . . . bottom of recess portion
3w, 3w′ . . . wall of recess portion
3P . . . optically transmissive particle
3S . . . optically transrnissive base material
LC . . . liquid crystal layer
70 . . . rear side substrate
71 . . . quarter-wave plate
72 . . . polarizing plate
73 . . . backlight
80 . . . pixel electrode layer
8t . . . transmissive electrode part
8r . . . reflective electrode part
81 . . . resist film
82 . . . bumps and dips adjustment film
83 . . . transparent conductor layer
84 . . . reflective conductor layer
90 . . . TFT-composite layer
91 . . . light shield film
92 . . . insulating layer
93 . . . source electrode
94 . . . drain electrode
95 . . . semiconductor layer
96 . . . gate insulating film
97 . . . second gate insulating film
L1 . . . transmitted light
L2 . . . reflected light

1. A color filter for coloring a first light ray having a unidirectional optical path and a second light ray having a bidirectional optical path for each pixel, comprising:
a first coloring portion for coloring the first light ray and a second coloring portion for coloring the second light ray, the first coloring portion having a greater thickness than the second coloring portion, the first coloring portion being formed in subsidence with respect to the second coloring portion with a principal plane of the first coloring portion being different in height from a principal plane of the second coloring portion by a predetermined value.

2. A color filter as defined in claim 1, characterized in that the predetermined value is a value required to substantially equalize or mutually optimize a first optical effect and a second optical effect, the first optical effect being to be exerted on the first light ray by a portion of a liquid crystal layer corresponding to the first coloring portion, and the second optical effect being to be exerted on the second light ray by a portion of the liquid crystal layer corresponding to the second coloring portion when the liquid crystal layer is used in a liquid crystal display panel to which the color filter is applied.

3. A color filter as defined in claim 2, characterized in that the optical effect is an effect of causing retardation.

4. A color filter as defined in claim 1, characterized in that the first and second coloring portions have their respective thicknesses such that the first coloring portion provides a greater coloring effect than the second coloring portion when a light ray of the same optical path and the same property is transmitted through the first and second coloring portions.

5. A color filter as defined in claim 4, characterized in that the first coloring portion has a thickness substantially twice as great as the second coloring portion.

6. A color filter as defined in claim 1, characterized in that the color filter further comprises a step-forming layer of an optical transmissive material, which supports the second coloring portion for providing the first and second coloring portions with thicknesses different from each other by the predetermined value.

7. A color filter as defined in claim 6, characterized in that the step-forming layer is colorless and transparent.

8. A color filter as defined in claim 1, characterized in that the step-forming layer includes an optically transmissive base material and multiple particles of optically transmissive material having a refractive index different from a refractive index of the base material and being scatteringly mixed into the base material.

9. A liquid crystal display device using a color filter for coloring a first light ray having a unidirectional optical path and a second light ray having a bidirectional optical path for each pixel, the color filter comprising:
a first coloring portion for coloring the first light ray and a second coloring portion for coloring the second light ray, the first coloring portion having a greater thickness than the second coloring portion, the first coloring portion being formed in subsidence with respect to the second coloring portion with a principal plane of the first coloring portion being different in height from a principal plane of the second coloring portion by a predetermined value.

10. A liquid crystal display device according to in claim 9, characterized in that:
the color filter is provided on a substrate at a display face side of the liquid crystal display device;
the opposite substrate is provided with a pixel electrode comprising a transmissive electrode part for causing the first light ray to be transmitted Page 3 of 6 therethrough and a reflective electrode part for causing the second light ray to be reflected therefrom; and
an area of the first coloring portion is aligned with an area of the transmissive electrode part, and an area of the second coloring portion is aligned with an area of the reflective electrode part.

11. A liquid crystal display device according to in claim 10, characterized in that the transmissive electrode part and the reflective electrode part have principal surfaces of substantially the same height.

12. A liquid crystal display device according to in claim 10, characterized in that there is a difference of height between principal surfaces of the transmissive electrode part and reflective electrode part, and a sum value of this difference of height and the predetermined value is a value required to substantially equalize a first optical effect and a second optical effect, the first optical effect being to be exerted on the first light ray by a portion of a liquid crystal layer corresponding to the transmissive electrode part, and the second optical effect being to be exerted on the second light ray by a portion of the liquid crystal layer corresponding to the reflective electrode part when the liquid crystal layer is used in a liquid crystal display device to which the color filter is applied.

13. A method of manufacturing a color filter for coloring a first light ray having a unidirectional optical path and a second light ray having a bidirectional optical path for each pixel, comprising the steps of:
depositing an optically transmissive material on a base layer;
patterning the deposited layer of optically transmissive material to form a step forming layer wherein at least one recess-shaped portion is formed for a pixel, the recess-shaped portion having a bottom face of a predetermined shape corresponding to an area wherein the first light ray is caused to be transmitted and a wall face of a predetermined height; and
depositing a material for coloring the first and second light rays on the step forming layer and the recess-shaped portion so as to form a first coloring portion for coloring the first light ray and a second coloring portion for coloring the second light ray, the first coloring portion having a greater thickness than the second coloring portion, the first coloring portion being formed in subsidence with a principal surface of the first coloring portion being different in height from a principal surface of the second coloring portion by a predetermined value.

14. A method of manufacturing a liquid crystal display device, comprising the steps included in a method as defined in claim 13, wherein
the color filter is provided to one substrate of the liquid crystal display device and the other, opposed substrate is provided with a pixel electrode comprising a transmissive electrode part for making the first light ray to be transmitted therethrough and a reflective electrode part for making the second light ray to be reflected therefrom,
the display device manufacturing method further comprising the step of aligning the first coloring portion with the transmissive electrode part and aligning the second coloring portion with the reflective electrode part.

15. A method as defined in claim 14, further comprising a pixel electrode forming step of forming the transmissive and reflective electrode parts in substantially the same heights.
